(19) United States
(12) Patent Application Publication
(10) Pub. No.: US 2008/0060334 A1
(43) Pub. Date: Mar. 13, 2008

(54) Systems and method for improving airflow in an onion topping device

(76) Inventor: Duane R. Kido, Parma, ID (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 11/517,898

(22) Filed: Sep. 8, 2006

(51) Int. Cl. A01D 41/08

(52) U.S. Cl. 56/130

(57) ABSTRACT

A harvesting and topping system includes a substantially horizontal cutting table for receiving a cultivated vegetable, the cutting table being pervious to air, a cutting assembly configured to cut vegetable tops of the cultivated vegetable when on the cutting table, at least one fan configured to blow air under positive pressure upwardly through the cutting table, and a ductwork configured to provide an airway from the fan to beneath the cutting table. According to one embodiment, the ductwork includes at least one airflow divider disposed in an interior portion of the ductwork to maximize uniformity of an air pressure within the ductwork and to distribute airflow within the ductwork.

### BACKGROUND OF THE INVENTION

Bulk harvesting of onions has traditionally been expensive and complex. Specifically, bulk harvesting of onions has traditionally been limited by the maneuverability of the harvester machinery in the onion field, the adaptability of the machinery to green or wet tops and onions of varying sizes, capacity of the machinery, and the ability of the machinery to prevent damage to the onions.

However, a number of systems and methods for the bulk harvesting of onions have been developed. For example, U.S. Pat. No. 2,553,519 (Lenz) discloses an onion topper in which an air stream, created by a fan, lifts the onion tops on a horizontal portion of an open flight conveyor where a reciprocating sickle blade cuts the lifted onion tops. In this reference, the fan (62) is shown in the drawings to be directly underneath the horizontal portion of the conveyor, and is recited in both claims to be vertically axised and mounted between the spaced portions of the conveyor runs.

The onion topper design disclosed in U.S. Pat. No. 2,553,519 allows debris in the form of stones, sticks, and clods of dirt to fall through the conveyor and onto the rotating blades of the fan, damaging the blades. Also, the air stream at the horizontal portion of the conveyor immediately above the fan is not uniform, resulting in uneven cutting of onion tops.

### SUMMARY

A vegetable harvesting and topping machine includes a front-end gathering and lifting assembly, a transport assembly connected to the gathering and lifting assembly for moving the cultivated vegetable upwardly and backwardly within the topping machine, a substantially horizontal cutting table that is pervious to air connected to the transport assembly for receiving the vegetable, a cutting assembly for receiving vegetable tops of vegetable on the cutting table, the cutting assembly being spaced apart above the cutting table, a discharge chute for receiving cut vegetable tops from the cutting assembly, a discharge assembly connected to the cutting table for receiving vegetables with their tops removed, at least one fan for blowing air under positive pressure upwardly through the cutting table, a ductwork which first extends down from the fan and then passes to beneath the cutting table, wherein the ductwork has at least one airflow divider disposed parallel to the curve of the interior of the ductwork, and a distributor foil which receives the airflow from the ductwork, the distributor foil being configured with at least one outlet vane

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a side view of an exemplary onion topper attached to a field tractor, according to one exemplary embodiment.

FIG. 2 is a partial side view, partially in cross-section, of the front-end gathering and lifting assembly of an exemplary onion topper, according to one exemplary embodiment.

FIG. 3 is a partial side view, partially in cross-section, of the onion transport assembly, substantially horizontal cutting table, cutting member, ductwork and distributor foil of an exemplary onion topper, according to one exemplary embodiment.

FIG. 4a, 4b, 4c and 4d are side, front, top, and back views respectively of an exemplary ductwork, according to one exemplary embodiment.

FIG. 5 is a partial side view of an exemplary ductwork, according to one exemplary embodiment.

FIG. 6a, 6b, 6c and 6d are side, back, top, and front views respectively of an exemplary ductwork, according to one exemplary embodiment.

FIGS. 7a and 7b are partial side views of an exemplary ductwork, according to one exemplary embodiment.

FIG. 8 is a top view, partially in cross-section, of the fans, ductwork, cutting member and onion discharge assembly of an exemplary onion topper, according to one exemplary embodiment.

FIG. 9 is a top view of the distributor foil of an exemplary onion topper, according to one exemplary embodiment.

FIG. 10 is a side, cross-sectional view of the distributor foil, of FIG. 10, according to one exemplary embodiment.

FIG. 11 is a top view of cutter assembly, according to one exemplary embodiment.

FIG. 12 is a flowchart of an exemplary method, according to one exemplary embodiment.

Throughout the drawings, identical reference numbers designate similar, but not necessarily identical, elements.

### DETAILED DESCRIPTION

The present system and method provide for a vegetable harvesting and topping machine. According to one exemplary embodiment, an onion topper with uniform pressure and airflow is provided by a ductwork with at least one airflow divider. An airflow divider is defined as a plane of material, being metal, plastic or otherwise, that is placed inside a ductwork, parallel to the airflow. As the name indicates, an airflow divider causes the airflow to divide into multiple flows, and can limit the asymmetrical distribution up of pressure and loss of velocity caused by corners in a ductwork. At least one airflow divider is placed in a first ductwork directing the flow of air from a fan to a second ductwork directly below a cutting table, thereby improving the uniformity of air flow to the cutting table. A distribution foil may further placed within the second ductwork beneath the cutting table, thereby further improving the uniformity of air flow to the cutting table, according to one exemplary embodiment. Additionally, an onion topper may be fitted with fans being placed parallel to the direction of the onion topper's movement, minimizing the problem of debris falling through the conveyor and onto the rotating fan blades.

Although the present exemplary embodiment is described, for ease of explanation only, in the context of being used for onion harvesting, the present exemplary vegetable harvesting and topping machine may be used for various vegetables.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

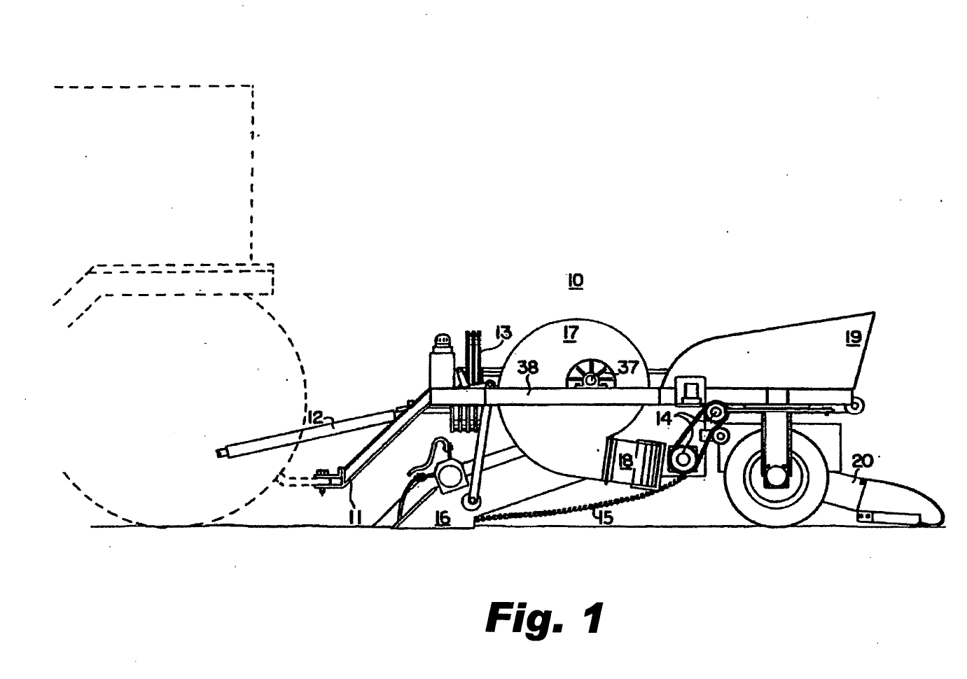

Referring to FIG. 1, an exemplary embodiment of an onion topper machine (100) using the present system and method is illustrated. As shown, the onion topper machine (100) is coupled to a tractor. While the present exemplary onion topper machine (100) is illustrated and described as being pulled behind and receiving rotational input from a tractor, the present exemplary vegetable harvesting and topping systems and methods may also be incorporated into a self-propelled vegetable topping apparatus. As shown in FIG. 1, the onion topper machine (100) is attached to a field tractor by a tongue member (110) and a power take-off shaft (112). The shaft (112) is connected to a series of pulleys and belts (114) which in turn are connected to a set of drive gears (116) to move a conveyor chain (118) and operate a front-end gathering and lifting assembly (120). Pulleys and belts (114) are also connected to fan (122) to blow air into ductwork (124). Ductwork (124) extends down from the fan (122) to a table-side orifice (not shown). Airflow from the fan (122) passes up to beneath discharge chute (126). The discharge chute (126) provides an exit for cut onion tops and other debris blown out from the cutting table and assembly (not shown in this FIG. 1). Discharge assembly (128) provides an exit for onions after their tops are removed, either to be laid in windrows behind the machine for field drying, or to be picked up by an onion loader for transport from the field. It should be noted that the fan axis (130) is above the machine frame member (132). Additionally, the front end gathering and lifting assembly (120) is comprised of many components which will now be discussed below.

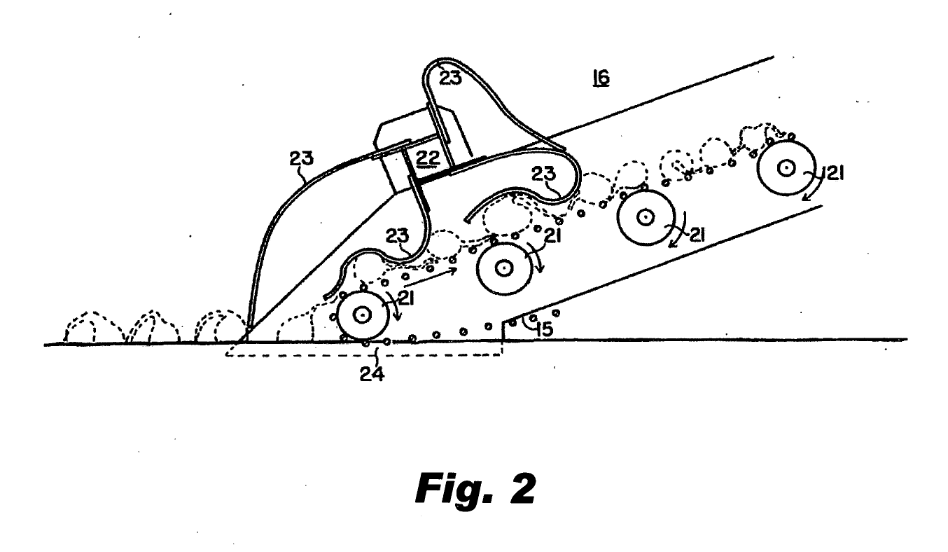

Referring to FIG. 2, there is depicted generally a front end gathering and lifting assembly (120) which is driven by a conveyor chain (118) suspended on rollers (210) and moving in the direction shown by the arrows. A flapper unit (212) with flapper pads (214) is driven by a gear and chain assembly (not shown) from the hub of one of the rollers (210). The flapper unit (212) gently coaxes the onions up off the ground and onto conveyor chain (118). A side blade (216), which may be adjusted to be on the surface of or in the ground, also helps to gently coax the onions up off the ground and onto the conveyor chain (118).

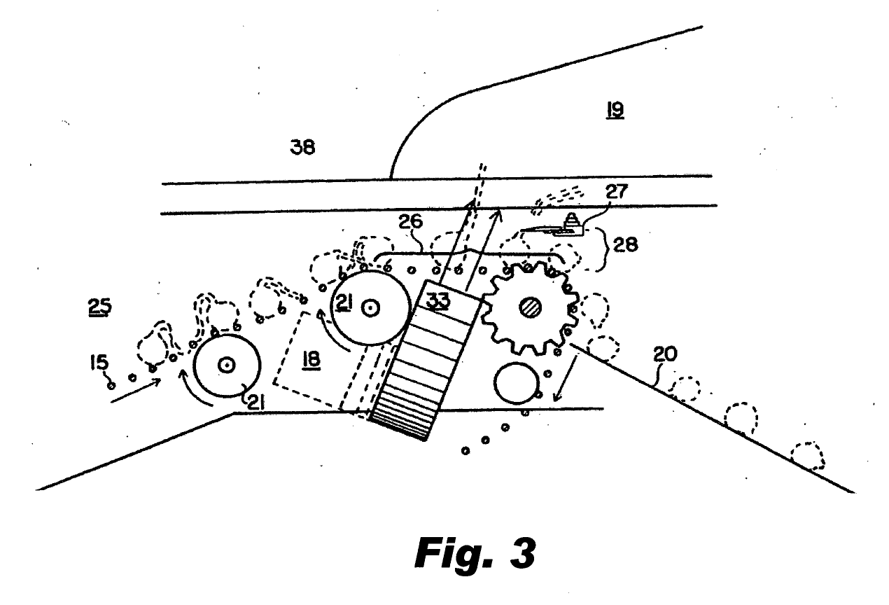

Referring to FIG. 3, there is depicted generally a transport assembly (300) for moving the onions upwardly and backwardly in the machine on a moving conveyor chain (118). The conveyor chain (118) being pervious to air allows clumps of dirt and rocks to fall off the onions as the conveyor moves. Also depicted generally is a substantially horizontal cutting table (310) provided by a level section of the moving conveyor chain (118). The Cutting table (310) is below the machine frame member (132). A sickle cutter member (312) is spaced apart an adjustable distance (314) above cutting table (310). According to one exemplary embodiment, the position of the sickle cutter member (312) enables the present exemplary system to accommodate both large and small onions.

Continuing with FIG. 3, ductwork (124) supplies a stream of air to the cutting table (310). As shown, the ductwork (124) initially extends down from the fan (122; FIG. 1). After exiting downward from the fan (122; FIG. 1), the airflow passes up the distributor foil (316) beneath the cutting table (310). A stream of air from the ductwork (124) is configured to blow up through the conveyor chain (118) as shown by the arrows in the area of the cutting table. The stream of air is configured to lift the lighter onion tops, but not the heavier bulbs, and extend the tops into the cutter member (312) where they are cut off and removed by being forced out the discharge chute (124) by the same stream of air.

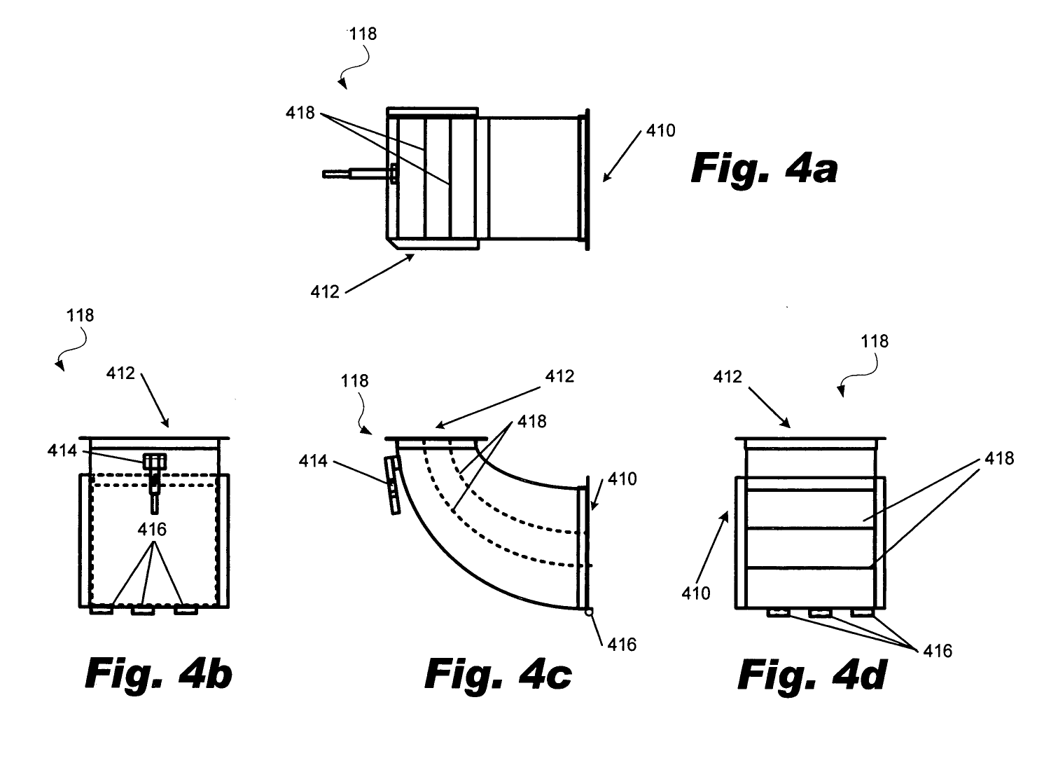

Once the tops of the onions or other produce is removed, the onions roll onto the discharge assembly (126), which may be a series of chutes and conveyors, and exit at the back of the machine. An exemplary ductwork will now be described in detail below with reference to FIGS. 4a through 11.

FIGS. 4a, 4b, 4c, and 4d generally depict an exemplary ductwork (118) configuration as seen at different angles, according to the present system and method. As shown, the present exemplary ductwork (118) includes at least two orifices. FIG. 4c illustrates a fan-side orifice (410) which is coupled to the output of the fan (122; FIG. 3). A second orifice is the table-side orifice (412) which is coupled to the input of the distributor foil (316; FIG. 3). The fan-side orifice (410) is depicted in the present Figs. as being the larger of the two orifices, but is not limited by such a comparison. As shown in FIGS. 4a through 4d, both the fan-side orifice (410) and the table-side orifice (412) are rectangular in shape. In other possible embodiments the orifices may be square, polygonal, circular, elliptical or other non-uniform shape. Also depicted is a locking latch (414) disposed along the outer side of the ductwork (118). A locking latch enables the ductwork (118) to be locked into place between the fan (122) and the distributor foil (316). Locking latch (414) may be engaged by exerting a force on the shank portion, causing the locking latch to rest tangentially (as demonstrated by FIG. 4c) to the outer curved surface of the ductwork (118). In contrast, a force may be exerted on the shank portion to disengage the locking latch (440), causing the locking latch to rest normally (as demonstrated in FIG. 4a) to the outer curved surface of the ductwork (118). Once the locking latch (414) is disengaged, the ductwork may be swung outward on an axis created by a hinge member (416).

As depicted in the exemplary embodiment of FIG. 4b-d, hinge member (416) can include a series of three hollow cylinders that could correspond to another series of hollow cylinders (not shown) found on the structure enclosing the fan (122, FIG. 1) through which a pin or pins maybe inserted to rotationally couple the ductwork (118) to the onion topper (100). The hinge member (416), however, is not limited to such a system or structure but may be configured in any way that allows for tangential rotation of the ductwork (118) toward and away from the ductwork (118). This movement is useful for non operational tasks such as, but not limited to, cleaning, repairs, maintenance, and the like.

In addition, according to one exemplary embodiment, FIGS. 4c and 4d illustrate a plurality of airflow dividers (418) configured to evenly distribute the air that passes through the ductwork (118). Referring to FIG. 4c, the ductwork (118; FIG. 1) may be configured to improve laminar airflow within the ductwork to deliver a more uniform pressure distribution that is delivered to the distributor foil (316; FIG. 3). In the exemplary ductwork (118) the air flow is impelled forward by a fan causing a plenum, or pressure slightly above atmospheric pressure. Because air flow has momentum, the majority of the air tends to collect at the back wall of a bend or curve in a ductwork (118). In the present exemplary embodiment the effect of a non-uniform pressure distribution is alleviated by placing at least one airflow divider (418) inside the ductwork (118) so as to channel a portion of the air flow away from the back wall of the ductwork (118). By selectively placing the at least one airflow divider (418) in the ductwork (118), the air pressure and flow is no longer concentrated at the back of the ductwork. As illustrated in FIG. 4c, the one or more airflow divider (418) is illustrated as being a thin plane or sheet of material. However, a number of alternate forms and shapes may be used to form the one or more airflow dividers (418) to improve pressure and velocity uniformity at the horizontal cutting table (310), according to one exemplary embodiment.

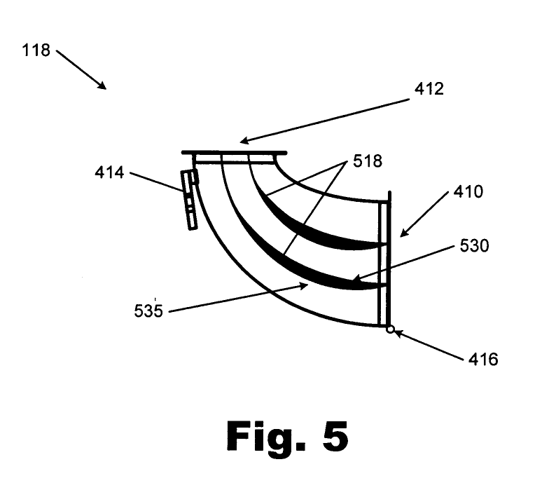

For example, FIG. 5 depicts a ductwork (118) with plurality of airflow dividers (518) that are in the shape of an airfoil, according to one exemplary embodiment. As shown, the ductwork (118) depicts similar components to those found in FIG. 4a-d, namely the fan side orifice (410), the table side orifice (412), the locking latch (414), and the hinge member (416). The one or more airflow dividers (518) in this exemplary embodiment include a curved inner surface (530), and slightly more curved outer surface (535). Using Bernoulli's principle, it can be shown that the velocity of the airflow around the outer curve (535) of the airflow divider (518) is higher than that on the inner curve (530). The increase in velocity is caused by a decrease in pressure along the surface of the outer curve (535). When the airflows along both inner (530) and outer (535) curves converge at the table side orifice (412) the velocities of the airflows are similar. Thus, both the uniformity of air pressure and velocity distribution of the air can be improved. While the present exemplary embodiment could use airflow dividers such as those described herein, any number of dividers can be used to provide the desired presser and velocity distribution. As will be seen below, the present exemplary system and method uses at least one air flow divider 2, but may use any number of dividers.

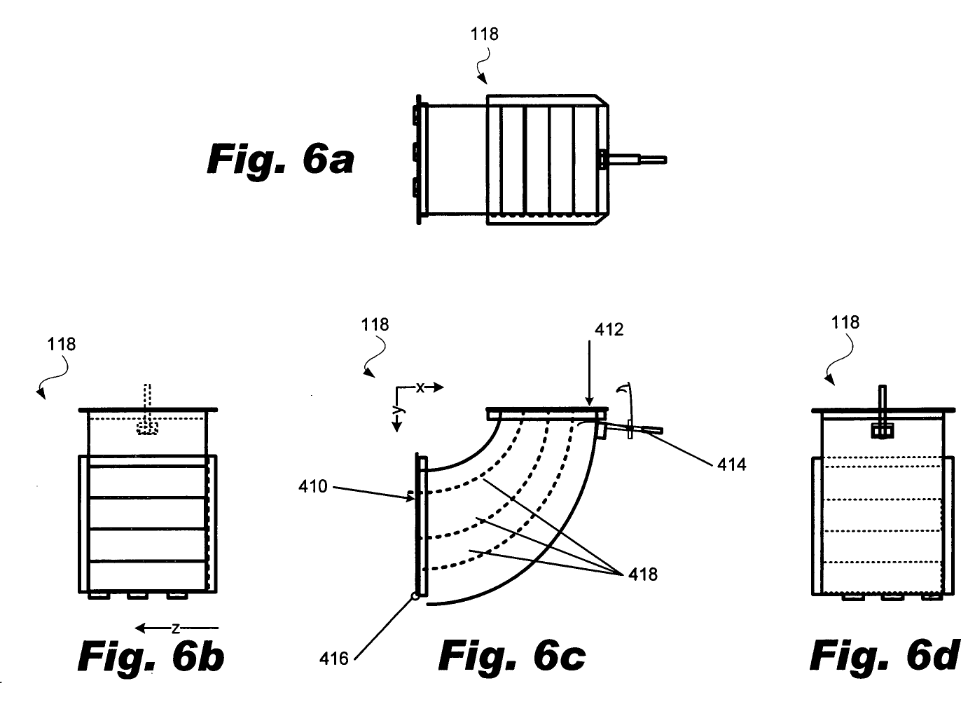

Varying the dimensions and/or shape of the ductwork (118) allows the ductwork, to be applied to any number of locations on the airflow system. Additionally, the number of dividers (418) may be increased to provide a higher degree of uniformity in the airflow. As shown in FIGS. 6a, 6b, 6c, and 6d, there is depicted an exemplary ductwork (118) seen at different angles according to the present system and method. As shown, the exemplary ductwork is similar to the ductwork depicted in FIGS. 4a-d. However, in the exemplary embodiment illustrated in FIGS. 6a through 6d, three airflow dividers (418) are disposed in the ductwork (118). An increase in number of dividers (418) present in the ductwork (118) can further improve pressure and air flow uniformity.

Additionally, according to one exemplary embodiment, the distance between the dividers (418) may vary depending on the shape and configuration of the ductwork (118). According to one exemplary embodiment, using the axes as indicated in FIG. 6c, the distance between airflow dividers (418) along to the y-axis, perpendicular to the fan side orifice (410) may range from 3-5 inches, according to one exemplary embodiment. The distance between airflow dividers (418) along to the x-axis, perpendicular to the table side orifice (412) may range from 2-3 inches, according to one exemplary embodiment. The width of the fan side orifice (410) parallel to the y-axis may also range from 9-20 inches, according to one exemplary embodiment. The exemplary width of the table side orifice (412) parallel to the x-axis may range from 6-12 inches. The height of the ductwork (118) parallel to the z-axis (as depicted in FIG. 6b) may range from 10-14 inches, according to the present exemplary embodiment. While a number of exemplary measurement ranges are provided herein, the spacing of the airflow dividers (418), as well as the widths of the orifices (410, 412) may vary. Additionally, the distances between the airflow dividers (418) may be uneven. According to one exemplary embodiment, the airflow dividers (418) may be closer together near the outer surface of the ductwork (118) to compensate for an un-even distribution of air in the ductwork.

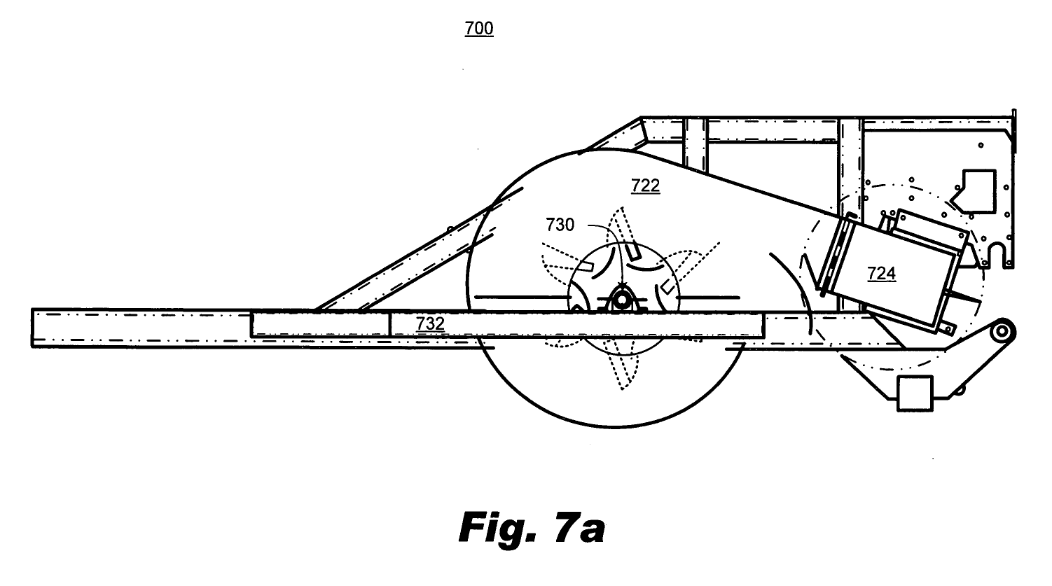

While a single onion harvester has been described above, any number of harvester configurations including ductwork will benefit from the inclusion of airflow dividers (418) therein. Referring now to FIGS. 7a and 7b, there is depicted a partial side view of an exemplary fan and ductwork according to principles described herein. According to one exemplary embodiment, the ductwork system (700) is very similar to that shown in FIGS. 1 and 2, with a few noticeable exceptions. The fan (722) is in a similar position as before and the fan-axis (730) is still above the machine member (732). However, as shown, the fan (722) is configured to blow in a clockwise direction causing the ductwork (724) to start from the top of the arc of the fan (722). This ductwork (724) orientation adds an extra protection against debris that falls through the conveyor chain (118). In FIG. 7b, a cut away view is provided to show where the airflow dividers (718) exit into the distributing foil (not shown), according to the present exemplary embodiment.

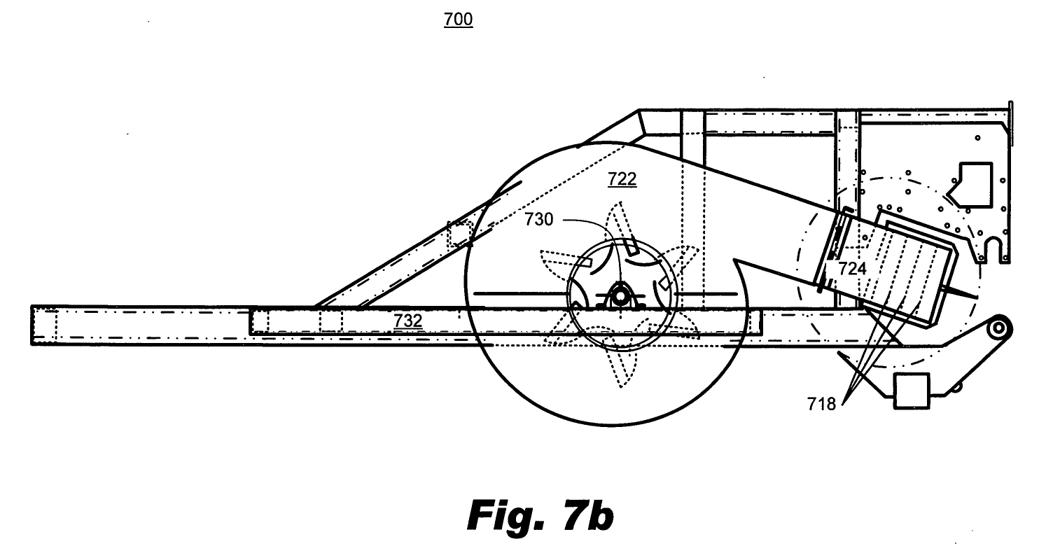

Referring to FIG. 8, there is depicted a top view of an exemplary onion topper according to principles described herein. As shown, two fans (122) having horizontally oriented axis and two sets of ductwork (124) are positioned to couple the outlet of the fans (122) to an area beneath the cutting table (310). A representative fan blade (810) is shown in the partially cross-sectioned portion of the fan (122). As illustrated, the ductwork (124) terminates in a relatively flat opening beneath the cutting table (310). Near the opening of the ductwork are provided outlet vanes (812) which make a distributor foil (316). These vanes are provided at logarithmic intervals transversely across the width of the opening so that, when the pressure drop in the distributor is taken into account, the air stream velocity across the distributor opening is uniform. Also shown is a cutter member (814) driven at or near its midpoint (816) by a connecting bar (818) to a revolving cam (820). The cam (820) is also driven by a series of pulleys and belts (not shown). Also shown in FIG. 8 is a roller conveyor (822) which receives the onions with their tops removed from the left-hand side cutting table (310), and directs them to the area of the exit from the right-hand side cutting table (310) where they are mixed together and exit at the back of the machine from the discharge assembly (126).

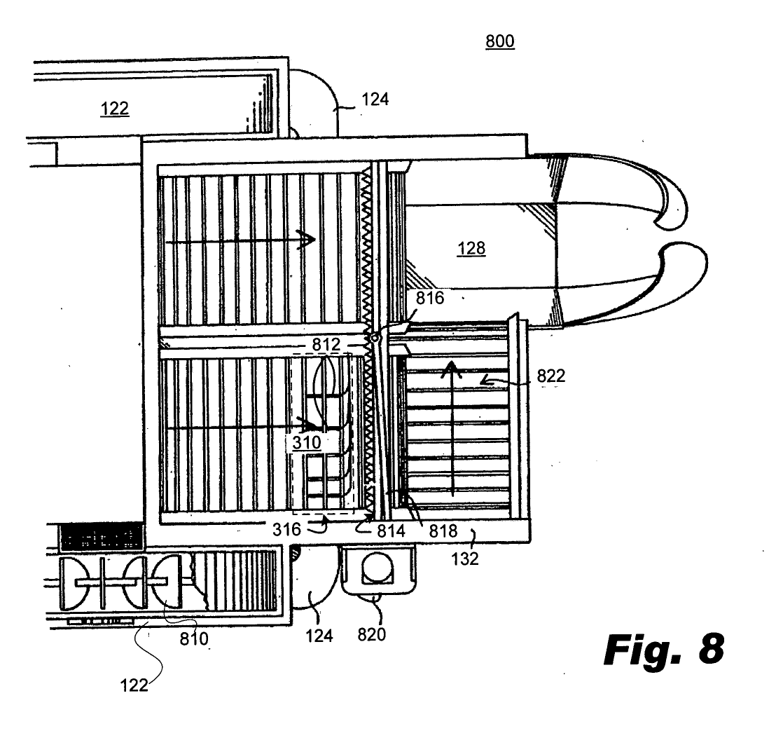

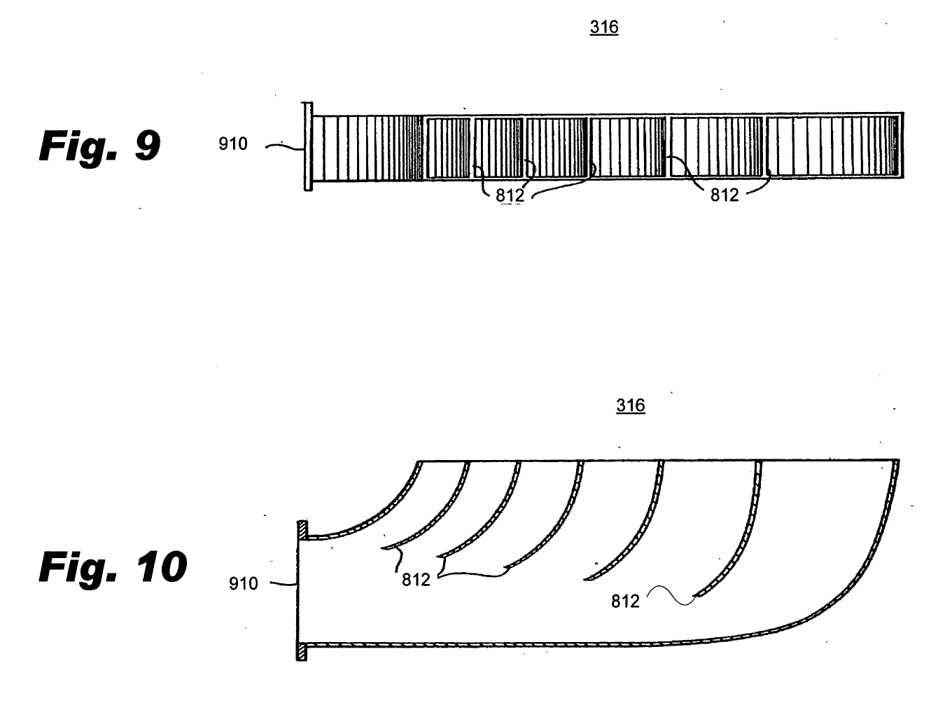

Referring now to FIG. 9, a top view the distributor foil (316) with inlet orifice (910) for connecting to the table-side orifice (412) of the ductwork (124) and the outlet vanes (812) is illustrated. Similarly, FIG. 10 illustrates a side, cross-sectional view of the distributor foil (812).

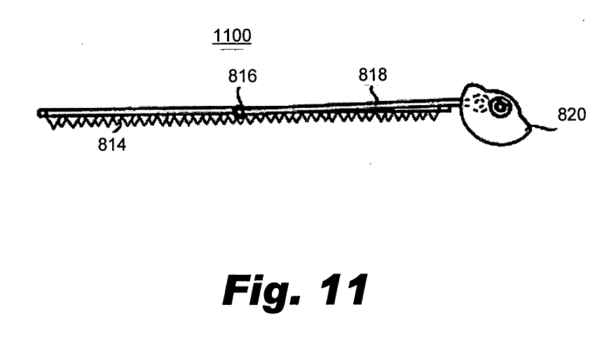

Referring to FIG. 11, there is depicted from a top view the cutting assembly (1100) with the cutter member (818) driven at or near its midpoint (816) by the connecting bar (818) to the revolving cam (820). The generally cylindrical cam (820) is configured by providing an eccentric weight equal in moment about the cam's axis to the weight-moment of the sickle cutter member (814) and the connecting bar (818). This way the cam (820) will rotate smoothly throughout each revolution, regardless whether connecting bar (818) is partially or fully extended, providing a smooth, reciprocating cutting action for the cutter member (814), and more even cutting of onion tops.

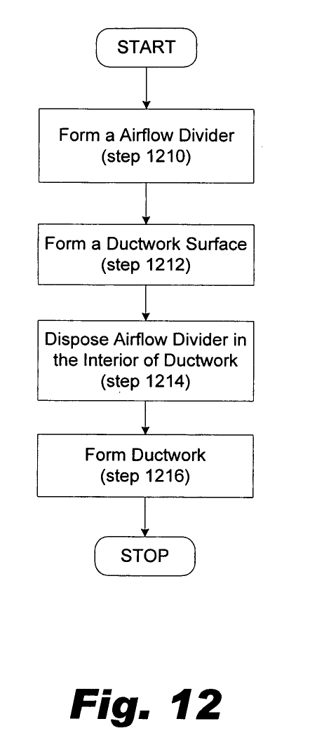

Referring now to FIG. 12, there is depicted a flowchart of an exemplary method for forming a ductwork with at least one airflow divider. As illustrated, the exemplary formation method may begin with the forming of an airflow divider (step 1210). As mentioned before an airflow divider can be manufactured out of, but is not limited to metals, alloys, plastics, composites, glasses, ceramics or the like. The forming of the divider may be done by forming a single flat sheet of material, cutting and curving it to the desired dimensions. Additionally, a divider that is configured to uniformly divide air pressure, velocity and airflow can be formed with two different curved surfaces. These surfaces will conform to the desired effect of a uniform distribution as described above. After the forming the divider a ductwork surface or frame may be formed (step 1212). This could include but is not limited to taking a sheet of the previously mentioned materials and shaping the walls of the ductwork by cutting and bending the material into the desired shape. As described above the shape of the ductwork may conform to, but is not limited to a square, rectangle, triangle, polygonal, circular, elliptical or other non-uniform shape.

After the ductwork shape has been formed at least one divider may be disposed along the interior of the ductwork surface (1214). The divider may be attached to the ductwork surface by, but is no way limited to the following methods, welding, an adhesive, coupling with fasteners such as screws, bolts, rivets, and the like.

Once the one or more dividers are in place, an enclosing ductwork is formed (1216). If the ductwork surface was formed without being a closed conduit, the ductwork is sealed. For example, an exemplary ductwork may include circular or angular openings and have a ninety degree curvature change, or an elbow member. Alternatively, the exemplary ductwork may form a less or more extreme angle.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. A harvesting and topping system, comprising:
a substantially horizontal cutting table for receiving a cultivated vegetable, said cutting table being pervious to air;
a cutting assembly configured to cut vegetable tops of said cultivated vegetable when on said cutting table, said cutting assembly being spaced apart above said cutting table;
at least one fan configured to blow air under positive pressure upwardly through said cutting table; and
a ductwork configured to provide an airway from said at least one fan to beneath said cutting table, wherein said ductwork includes at least one airflow divider disposed in an interior portion of said ductwork.

2. The system of claim 1, wherein said ductwork further comprises a distributor foil coupled to said ductwork opposite said at least one fan, wherein said distributor foil includes at least one outlet vane.

3. The system of claim 1, wherein said at least one airflow divider is configured to:
maximize uniformity of an air pressure within said ductwork; and
distribute airflow within said ductwork to said distributor foil.

4. The system of claim 3, wherein said air flow divider further comprises:
an inner surface; and
an outer surface;
wherein a curvature of said inner surface is shallower than a curvature of said outer surface.

5. The system of claim 4, wherein said curvature of said inner surface and said curvature of said outer surface are configured to ensure that a velocity of air traveling adjacent to said inner surface and a velocity of air traveling adjacent to said curved outer surface obtain an identical velocity at an exit of said ductwork.

6. The system of claim 2, wherein said distributor foil further comprises:
a plurality of outlet vanes disposed in a terminal opening of said distributor foil;
wherein said plurality of outlet vanes are disposed at logarithmic intervals transversely across a width of said terminal opening.

7. The system of claim 2, wherein said ductwork further comprises a locking latch configured to alternately engage and disengage said ductwork to an inlet of said distributor foil.

8. The system of claim 7, wherein said ductwork further comprises a hinge member configured to allow said ductwork to axially rotate relative to said inlet of said distributor foil.

9. The system of claim 1, wherein said ductwork is configured to receive an input of air from said at least one fan and redirect said input of air at least 90 degrees with an elbow member; and
wherein said at least one airflow divider is disposed within said elbow member.

10. A harvesting and topping apparatus, comprising:
a front-end gathering and lifting assembly;
a transport assembly coupled to said gathering and lifting assembly, said transport assembly being configured to move a cultivated vegetable upwardly and backwardly within said topping apparatus;
a substantially horizontal cutting table coupled to said transport assembly, said cutting table being pervious to air;
a cutting assembly disposed on said cutting table, said cutting assembly being spaced above said cutting table;
a discharge chute configured to receive cut vegetable tops from said cutting assembly;
a discharge assembly coupled to said cutting table configured to receive vegetables with their tops removed;
at least one fan configured to direct air under positive pressure upwardly through said cutting table;
a ductwork configured to provide an airway from said at least one fan to beneath said cutting table, wherein said ductwork includes at least one airflow divider disposed in an interior portion of said ductwork; and
a distributor foil having at least one outlet vane, wherein said distributor foil is coupled to said ductwork opposite said at least one fan.

11. The apparatus of claim 10, wherein said air flow divider further comprises:
an inner surface; and
an outer surface;
wherein a curvature of said inner surface is shallower than a curvature of said outer surface.

12. The apparatus of claim 11, wherein said curvature of said inner surface and said curvature of said outer surface are configured to ensure that a velocity of air traveling adjacent to said inner surface and a velocity of air traveling adjacent to said curved outer surface obtain an identical velocity at an exit of said ductwork.

13. The apparatus of claim 10, wherein said distributor foil further comprises:
a plurality of outlet vanes disposed in a terminal opening of said distributor foil;
wherein said plurality of outlet vanes are disposed at logarithmic intervals transversely across a width of said terminal opening.

14. The apparatus of claim 10, wherein said ductwork is configured to receive an input of air from said at least one fan and redirect said input of air at least 90 degrees with an elbow member; and
wherein said at least one airflow divider is disposed within said elbow member.

15. A method of making a ductwork, comprising:
forming at least one airflow divider;
forming a ductwork surface;
disposing at least one airflow divider along the interior of said ductwork surface; and
completing an outer surface of said ductwork.

16. The method of claim 15, wherein forming said at least one airflow divider comprises forming said airflow divider from a single curved plane.

17. The method of claim 15, wherein forming said at least one airflow divider comprises:
forming a curved inner surface having a first curvature; and
forming a curved outer surface having a second curvature;
wherein said first curvature and said second curvature are not equal.

18. The method of claim 17, wherein said first curvature and said second curvature are configured to provide laminar air flow around said at least one airflow divider.

19. The method of claim 18, wherein said first curvature and said second curvature are further configured to ensure an even pressure distribution at an exit of said ductwork.

20. The method of claim 15, wherein said forming a ductwork surface comprises forming an elbow member; and
wherein said disposing at least one airflow divider along the interior of said ductwork surface includes disposing said at least one airflow divider in said elbow member.
